(19) United States
(12) Patent Application Publication
(10) Pub. No.: US 2026/0306325 A1
(43) Pub. Date: Oct. 8, 2026

(54) TURNING APPARATUS

(71) Applicant: Silver Lion Innovations Limited, Edinburgh (GB)

(72) Inventors: Ruth Brenda CROZIER, Edinburgh (GB); Stephen Alexander MCLAREN, Edinburgh (GB); Conor James CROZIER, Edinburgh (GB)

(21) Appl. No.: 19/485,792

(22) PCT Filed: May 20, 2024
(86) PCT No.: PCT/GB2024/051309

§ 371 Date: Nov. 19, 2025

(30) Foreign Application Priority Data
May 19, 2023 (GB) 2307567.4

(51) Int. Cl. A61G 7/057

(52) U.S. Cl. CPC A61G 7/057; A61G 2200/32

(57) ABSTRACT

An apparatus for turning a person on a mattress of a bed, the apparatus comprising: one or more first expandable bodies capable of providing cushioning between the top sheet and the mattress in a first portion of the mattress; and one or more second expandable bodies capable of providing cushioning between the top sheet and the mattress in a second portion of the mattress; the apparatus configured to maintain the person in a controlled location on the mattress.

### FIELD OF THE INVENTION

The present invention relates to an apparatus for turning a person on a mattress of a bed, and to a bed comprising this apparatus. The bed may be a profiling bed.

### BACKGROUND TO THE INVENTION

It is known to provide a bed for a person to lie upon, for example in a care environment. People with neurological health conditions such as Parkinson's may at a certain stage require some assistance with mobility. Persons can be manually turned to alleviate the development of pressure sores, which may happen if the person has limited mobility or must otherwise spend extended periods of time in bed. However, this is time and resource consuming. It is in this context that the present inventions have been devised.

### SUMMARY OF THE INVENTION

In a first aspect there is provided an apparatus for turning a person on a mattress of a bed. Typically, the apparatus is for turning a person at a controlled location on a mattress of a bed, the apparatus configured to maintain the person at the controlled location on the mattress. It may be that the apparatus comprises one or more first expandable bodies and one or more second expandable bodies. Typically, expansion and contraction of the expandable bodies may be used to turn or rotate the person. Typically, the one or more first expandable bodies and one or more second expandable bodies are capable of overcoming the inertia of a person lying on a mattress of a bed (in a generally horizontal position).

The controlled location on the mattress may be, but need not be, centrally on the mattress. That is to say, the apparatus may be configured to maintain the person centrally on the mattress, meaning that the person lies on the mattress along its length with upper mattress surface area available both right and left of the person. The amount of upper mattress surface area available both right and left of a person lying on the mattress may be, but need not be, approximately equal. The controlled location may be the current location of the person.

Turning a person on a mattress of a bed means rotating a person recumbent on a bed around their longitudinal axis. For example, turning a person on a mattress of a bed may reorient a person recumbent on one of their sides to be recumbent on their back, or on their other side. Turning a person on a mattress of a bed may result in the person being turned by at least 90°, or by at least 135°, or by at least 180°, or by at least 225°, or by at least 270°. It may be that turning a person on a mattress of a bed may result in the person being turned by less than 270°, or less than 180°, or less than 135°, or less than 90°.

By turning a person at a controlled location on a mattress of a bed, the person is turned on the bed.

In accordance with a second aspect of the present invention, there is provided an apparatus for turning a person on a mattress of a bed, the apparatus comprising: one or more first expandable bodies capable of providing cushioning between the top sheet and the mattress in a first portion (e.g. half) of the mattress; and one or more second expandable bodies capable of providing cushioning between the top sheet and the mattress in a second portion (e.g. half) of the mattress. Hereafter reference to “expandable body” is taken to include both an expandable body in the singular, and a plurality of expandable bodies, possibly adjacent to one another. The first and second portions (e.g. halves) are typically transversely spaced. Therefore each portion is on the opposite side of a person lying along the bed in use. The apparatus may comprise the mattress. The mattress may comprise one or more first expandable bodies and the one or more second expandable bodies.

The person skilled in the art will understand that a portion of the mattress means an area which is a proportion of the upper surface area of the mattress, upon which a person using the bed is located. The person may lie between the first portion and the second portion. The person may lie at least in part on the first portion and on the second portion. The person may lie between the one or more first expandable bodies and the one or more second expandable bodies. The person may lie on at least part of the one or more first expandable bodies and on at least part of the one or more second expandable bodies, for example when the expandable bodies are deflated.

Expansion, e.g. inflation, or contraction, e.g. deflation, of one or more first (or second) expandable bodies, or contraction of one and expansion of the other, leads to a vertical movement causing the person to rotate and therefore be turned. It may be that one or more second (or first) expandable body is at the same time held in an expanded state, or contracted, to facilitate the rotation of the person while continuing to control their location on the mattress of the bed. It may be that as this occurs, the sheet slips (displaces) relative to the expanding body, so the person is turned in contact with the same part of the sheet, thereby avoiding significant slip. This also facilitates control of the location of the person on the mattress of the bed.

The one or more first expandable bodies may be expandable (e.g. inflatable) independently of the one or more second expandable bodies. The one or more second expandable bodies may be expandable (e.g. inflatable) independently of one or more first expandable bodies.

Where the one or more first expandable bodies comprises a plurality of first expandable bodies, it may be that the plurality of expandable bodies are expanded together. It may be that the plurality of expandable bodies are in fluid communication. It may be that the plurality of first expandable bodies can be expanded independently of each other.

Where the one or more second expandable bodies comprises a plurality of second expandable bodies, it may be that the plurality of the one or more second expandable bodies are in fluid communication and expanded together. It may be that the plurality of one or more second expandable bodies can be expanded independently of each other.

The mattress typically has a thickness. An expandable body, such as forming part of one or more first expandable bodies or the one or more second expandable bodies or both, may extend in a non-expanded state partially or entirely through the thickness of the mattress.

The apparatus may further comprise a top sheet which, when the apparatus is fixed to the bed, extends across the mattress; whereby the top sheet is displaceable across the one or more first expandable bodies and the one or more second expandable bodies. The mattress may be of the bed. The mattress may be of the apparatus.

The cushioning may be inflated cushioning. The one or more first expandable bodies may comprise one or more mechanically or chemically expandable bags.

The one or more first expandable bodies may comprise one or more inflatable chambers, e.g. one or more inflatable bags. The inflatable chamber may comprise a pocket or a plurality of pockets. The one or more first expandable bodies may comprise a plurality of inflatable chambers. The one or more first expandable bodies may comprise a first inflatable chamber within a second inflatable chamber. The first inflatable chamber may be inflatable independently of the second inflatable chamber. The second inflatable chamber may be inflatable independently of the first inflatable chamber.

The one or more second expandable bodies typically are similar to the one or more first expandable bodies. The one or more second expandable bodies may be the same as the one or more first expandable bodies. The one or more second expandable bodies may mirror the one or more first expandable bodies. The one or more second expandable bodies may comprise one or more mechanically or chemically expandable bags. The one or more second expandable bodies may comprise one or more inflatable chambers. The one or more second expandable bodies may comprise plurality of inflatable chambers.

The one or more first expandable bodies and the one or more second expandable bodies may be joined or may be separated from each other by a gap lengthwise down the length of the mattress. The length of the mattress runs in the direction in which a person would lie on the mattress.

The one or more first expandable bodies may provide inflated cushioning when a gas, typically air, is supplied into the inflatable chamber. The air is supplied at an over-pressure, for example 0.5 bar over atmospheric pressure.

The one or more first expandable bodies may comprise deflation means to deflate the one or more first expandable bodies from a state of inflation or partial inflation. The deflation means may comprise a valve.

The one or more first expandable bodies may comprise an inflator bag. The inflator bag may have an essentially rectangular outer form. The corners of the rectangular form may be, but need not be, curved.

The one or more first expandable bodies may be seamed. The one or more first expandable bodies may have a first layer which forms a first side of the body and a second layer which forms a second side of the body whereby a seam joins said first layer to said second layer. The seam may be around the outer edges of the first layer and the second layer. The seam may be a single seam.

The one or more second expandable bodies typically has the same structure and functionality as the one or more first expandable bodies.

Each of the one or more first expandable bodies and the one or more second expandable bodies is preferably waterproof. Each of the one or more first expandable bodies and the one or more second expandable bodies is preferably robust.

Each of the one or more first expandable bodies and the one or more second expandable bodies should typically withstand multiple cycles of expansion and contraction.

Each of the one or more first expandable bodies and the one or more second expandable bodies is preferably non-stretchy. Having an expandable body which is non-stretchy minimises the loss of energy when the body is expanded.

The top sheet is displaceable across the one or more first expandable bodies and the one or more second expandable bodies. The displaceability of the top sheet is typically in a direction of displacement which is breadthwise across the bed.

The top sheet may have a surface on one side which is slippery. This is to reduce friction between the first and second one or more expandable bodies and the top sheet when the top sheet displaces across the expandable bodies. It may be that the sheet has a lower friction surface on one side than on the other side. The lower friction surface may be the lower side in use. The other, higher friction, surface may be the upper side in use.

The surface of the one or more first expandable bodies which is intended to be in contact with the top sheet is typically slippery. The surface of the one or more second expandable bodies which is intended to be in contact with the top sheet is similarly typically slippery. This is to reduce friction between the first and second one or more expandable bodies and the top sheet when the top sheet displaces across the expandable bodies.

The top sheet may have a high tensile stress.

The top sheet may have a surface on the second side which has a high friction texture. The second side of the top sheet is the side which may have contact with a person on the bed. It is generally desirable that a person in contact with the surface of the second side of the top sheet does not slide or slip on the sheet. This is particularly desirable during the process of operating the apparatus to turn the person. The top sheet may have waterproofing capabilities. For example, the top sheet may have resistance to the ingress of water or liquid. This has the effect of diminishing the passage of liquid, for example sweat or urine, through the apparatus and soiling the apparatus and/or bed.

The top sheet may be breathable. This has a positive effect on the comfort of a person on the bed.

The apparatus may comprise a first elongated retainer. The first elongated retainer may act to retain the top sheet along said first side of the bed. The first elongated retainer may be for attachment to a first side of the bed. The first elongated retainer may be for attachment outwith the bed, for example to the floor on which the bed is placed or affixed.

The apparatus generally also comprises a second elongated retainer. The second elongated retainer is typically for retaining the top sheet along said second side of the bed, whereby when the apparatus is mounted on the bed, the top sheet is retained on the mattress by said first elongated retainer and said second elongated retainer. The elongated retainer may be demountably attached to side rails of the bed. The elongated retainer may be demountably attached externally to the bed.

Each of the first elongated retainer and the second elongated retainer may be attached outwith the bed, for example to the floor on which the bed is placed or fixed.

Each of the first elongated retainer and the second elongated retainer may be sized such as to form a safety barrier preventing a person lying on the mattress from falling off the bed.

The apparatus may further comprise a top sheet feed system configurable to hold top sheet material at a first side of the bed and contemporaneously to wind or unwind top sheet at a second side of the bed.

The top sheet feed system may comprise a first roller system which extends along the length of the mattress or bed. The first roller system typically comprises a first roller. The first roller system typically retains the top sheet at a first side of the mattress. The first roller system may feed top sheet material breadthwise towards the mattress. The first roller system may lock, so that top sheet material may not be fed from it breadthwise towards the mattress. Furthermore, the first roller system may, as required, wind in top sheet material, winding it onto the roller, thereby taking up top sheet material breadthwise from the mattress.

The top sheet feed system may comprise a second roller system which extends along the length of the mattress or bed. The second roller system typically comprises a second roller. The second roller system typically retains the top sheet at a second side of the mattress. The second roller system may feed top sheet material breadthwise towards the mattress. The second roller system may lock, so that top sheet material may not be fed from it breadthwise towards the mattress. Furthermore, the second roller system may, as required, wind in top sheet material, winding it onto the roller and thereby take up top sheet material breadthwise from the mattress.

The top sheet feed system may comprise the first roller system and the second roller system. The first roller system may be controlled in concert with the second roller system. The first roller system may be controlled in concert with the expansion of an expandable body. The apparatus may be operated in such a way that one of the first roller system and the second roller system is locked and the other winds top sheet material onto the roller, or unwinds top sheet material from the roller. Such an operation facilitates maintaining a person on the bed in a roughly central position during turning. The first roller and the second roller may also wind or unwind top sheet material in concert. A person may advantageously be turned on the spot rather than rolled over.

Each of the first roller system and the second roller system may be attachable to the bed. Alternatively, each of the first roller system and the second roller system may be attachable external to the bed, in such a way that the top sheet is displaceable across the one or more first expandable bodies and the one or more second expandable bodies when on the bed. For example, when in use the bed may be attached to a floor of the room within which the bed is located. Under these conditions, each of the first roller system and the second roller system may also be attached to the floor, or to a side wall of the room, and in such a way that the top sheet is displaceable across the bed.

The top sheet conveyor system comprising the first roller, the second roller and the top sheet, may be used to convey a person into the middle of the bed when they are getting on it.

In an alternative arrangement, the top sheet may take the form of a closed loop. In this arrangement, the top sheet loops around the mattress and the one or more first expandable bodies and the one or more second expandable bodies. The top sheet is continuously displaceable across the one or more first expandable bodies and the one or more second expandable bodies by rotating the looped top sheet around its central axis.

The apparatus may further comprise fixing means for fixing said apparatus to the bed.

The fixing means may fix the apparatus to the bed by fixing the first and the second one or more expandable bodies to the bed, for example to the mattress of the bed. The fixing means may run down an edge of an expandable body, for example down an edge of the one or more first expandable bodies, or down an edge of the one or more second expandable bodies, or down an edge of both first and second one or more expandable bodies. The fixing means may be arranged down the edge of expandable body to be placed towards an edge of the mattress. The fixing means may comprise a hook and loop connection. The fixing means may comprise a popper fastener. The fixing means may comprise a strap which is fixedly attached to the apparatus, for example to the expandable body, and which serves to strap the apparatus to the bed, for example to the mattress. For example, the strap may pass around the mattress to fix the apparatus to the mattress. A plurality of straps may be provided.

The fixing means may restrain the expandable body and keep it connected to the mattress during expansion, for example, during inflation.

The one or more first expandable bodies may comprise an inflatable chamber.

An air supply may be provided to supply pressurised air to an inflatable chamber to inflate it. An inflatable chamber may be inflated and subsequently deflated. An inflatable chamber may therefore be brought into inflated or deflated configurations repeatably and with ease.

The inflatable chamber may be of polyurethane, polyester, polyvinylchloride (PVC), or polychloroprene of neoprene. Each of these materials has the advantage that it is biocompatible. These materials have a low propensity for building up static and are waterproof.

The inflatable chamber may be biocompatible. The inflatable chamber may be low static. The inflatable chamber may be waterproof.

Each of the one or more first expandable bodies and the one or more second expandable bodies may be a single cavity inflatable chamber.

The inflatable chamber may be seamed. The inflatable chamber may have a first layer which forms a first side of the inflatable chamber and a second layer which forms a second side of the inflatable chamber, whereby a seam joins said first layer to said second layer. The seam may be around the outer edges of the first layer and the second layer. The inflatable chamber may have one seam which runs along the length of the chamber.

The one or more first expandable bodies may comprise a plurality of inflatable chambers. Each of the plurality of inflatable chambers which together form the one or more first expandable bodies (for example) may be individually sized so as to structure a desired shape of the one or more first expandable bodies in its expanded or inflated form. This applies equally to the one or more second expandable bodies.

The plurality of inflatable chambers may be arranged in a layered structure.

What is meant by the plurality of chambers being arranged in a layered structure is that a first inflatable chamber of the plurality of chambers is overlaid by the second inflatable chamber of the plurality of chambers, which in turn is overlaid by a third inflatable chamber of the plurality of chambers, and so on. The second inflatable chamber may completely overlie the first inflatable chamber. The second inflatable chamber may partially overlie the first inflatable chamber. For example, the second inflatable chamber may have a breadth which is less than the breadth of the first inflatable chamber, against which it lies. The third inflatable chamber may have a breadth which is less than the breadth of the second inflatable chamber, against which it lies.

The plurality of layered chambers forming an expandable body may be substantially aligned along an edge of each chamber. The plurality of layered chambers forming an expandable body may be substantially aligned along a side edge of each chamber.

Each of the plurality of inflatable chambers may comprise a flap. Typically the flap is non-inflatable and serves as a structure to help anchor the inflatable chamber to a surface on which the expandable body is positioned. Such a surface may be a mattress of a bed upon which the apparatus is placed. Such a surface may be a base sheet of the apparatus, which is envisaged as being placed on the mattress. Such a surface may be a flap of an inflatable chamber. A flap may comprise attaching means for attaching the inflatable chamber to a surface. An expandable body may comprise a flap. Each of a plurality of inflatable chambers of an expandable body may be attached to the flap.

The one or more second expandable bodies is typically structured in the same way as the one or more first expandable bodies.

The apparatus may comprise an additional expandable body, for example, an inflatable chamber, positioned, when expanded or inflated, to stop the knees of a person lying on the bed from knocking together. This additional expandable body may be part of the first and/or the second one or more expandable bodies.

The apparatus may comprise an additional expandable body, for example, an inflatable chamber, positioned to act as a support for the head of a person lying on the bed. This additional expandable body may be part of the first and/or the second one or more expandable bodies.

The apparatus may comprise an additional expandable body or bodies, for example, an inflatable chamber or chambers, which act in concert with the one or more first expandable bodies and the one or more second expandable bodies when turning a person on the bed. These additional expandable bodies may support areas of the person, such as the head and shoulders, the thigh area, and the leg area. During rotation of the person on the bed, these additional expandable bodies may assist with the rotation and support areas of the person, such as the head and shoulders, the thigh area, and the leg area during said rotation. A more natural body roll is thereby achieved. Inflation of an inflatable chamber, e.g. an airbag, may move (e.g. displace or rotate) another inflatable chamber.

The apparatus may comprise an additional expandable body, for example, an inflatable chamber, positioned over the expandable body or bodies, to provide for the comfort of a person lying on the bed.

An inflatable chamber may be configured so that, during inflation, it curls around itself, and/or rotates around an axis. This aids turning the person on the bed by providing an increased turning force.

The apparatus may further comprise an air supplier for supplying air to each of the one or more first expandable bodies and each of the one or more second expandable bodies. The air supply is typically controlled by the controller.

The air supplier may comprise a pump, for example a diaphragm air pump. The air supplier may be housed in a control box. The control box may hook over the end of the bed.

Air may be supplied to an expandable body to inflate the expandable body, either partially or fully.

Air may be supplied from an air supply, such as a mains supply or a contained supply. Air may be supplied through the control box. An external air supply may supply air under pressure to the control box, from where the air is controllably passed onto the expandable bodies.

The apparatus may further comprise a vent for controllably releasing air from an air bag.

A vent for controllably releasing air may be provided for each air bag. Each expandable body may comprise a controllable valve through which air may be expelled. An inflated cushion may in this manner be controllably deflated.

An inflated air bag may be controllably deflated slowly, for example over a period of 30 seconds or more, or it may be controllably deflated rapidly, for example over a period of 15 seconds or less. Rapid deflation may be motorised, thereby controlling the rapidity of the deflation by releasing air in a controlled manner. Rapid deflation may also be initiated in an emergency, for example by pulling an emergency cord and thereby activating a rapid deflation of the air bags.

The apparatus may be configured such that the top sheet feed system operates in cooperation with the air supplier and/or the vent of an expandable body.

For example, if the controller causes an expandable body on one side of the bed to inflate to turn a person lying on the bed, the controller may also arrange for the top sheet feed system to hold the top sheet material at the same side of the bed and to contemporaneously unwind top sheet material from roller at the other side of the bed. The combination of the inflation of the expandable body on one side of the bed and the lateral displacement of the top sheet material has the effect of turning the person, while keeping the person in a controlled location on the mattress.

When the controller causes an inflated expandable body to deflate, thereby returning a person on the mattress from a lateral recumbent position to a supine position (for example), the controller may also control the top sheet feed system so that slack top sheet material is taken up. In this way the top sheet may be kept taut across the mattress.

The apparatus may further comprise a base sheet, whereby the one or more first and the one or more second expandable bodies are positioned in a layer between the base sheet and said top sheet.

The one or more first and the one or more second expandable bodies may be attached to the base sheet. For example, the first and second expandable bodies may be attached to the base sheet by hook and loop connections. The first and second expandable bodies may be plastic welded to the base sheet. Alternative fixtures, such as popper fixtures, are possible.

The apparatus may further comprise one or more sensors. The one or more sensors may be one or more temperature sensors. A temperature sensors or temperature sensors enable sensing of the temperature of a person. Whether a person is too hot or too cold may thereby be determined. The one or more sensors may be one or more moisture sensors. A moisture sensor or moisture sensors enable moisture to be sensed. For example, incontinence may be sensed with such a sensor or sensors. The one or more sensors may be one or more pressure sensors. A pressure sensor or pressure sensors enable the pressure to be sensed at a point or points on the bed. Positional needs of a person on the bed may thereby be determined. For example, the position of a person on the bed may be sensed to enable the person to be centred on the bed. The one or more sensors may be one or more weight sensors. The weight of a person on the bed may thereby be sensed or monitored, for example over time. The one or more sensors may be a combination of sensors for sensing temperature, moisture, pressure, or weight.

The one or more sensors may be located in the top sheet. The one or more sensors may be located in a sensor sheet. The sensor sheet may be located between, adjacent one side of the sensor sheet, the top sheet and, adjacent the second side of the sensor sheet, the one or more first and the one of more second expandable bodies.

Control of the apparatus by the controller may be affected by a signal or signals from the one or more sensors. For example, if no person is sensed on the bed by the one or more pressure sensors, the one or more first expandable bodies may be deflated, and the one or more second expandable bodies may be deflated.

In accordance with a third aspect of the present invention, the present specification discloses a bed comprising an apparatus according to the first aspect or the second aspect. The apparatus may comprise a mattress.

In a fourth aspect of the present invention, the specification discloses a method of operating a bed according to the third aspect, said method comprising expanding the one or more first expandable bodies and contemporaneously feeding the top sheet so that it displaces laterally across the bed, to thereby turn the person in a controlled location on the bed. In this way a person may be turned from a supine position to a lateral recumbent position. A person may also be turned from a prone position to a supine or to a lateral recumbent position. The person may be a bariatric person.

The method may comprise a step of attaching a sheet or sheets, for example the top sheet, to the apparatus using a hook and loop system.

Typically, the top sheet is fed so to displace in a breadthwise direction. Typically, the top sheet displaces in a breadthwise direction. A breadthwise direction is generally perpendicular to the direction along which the person lies on the bed. Typically, the top sheet is fed so that it displaces across the one or more first expandable bodies and the one or more second expandable bodies. The top sheet may be unwound from the roller system. The roller system may be controllable driven to unwind top sheet.

A first step of the method may comprise partially expanding, for example inflating, each of the one or more first expandable bodies and the one or more second expandable bodies, thereby supporting a supine person on two peripheral sides of the person. A second step may comprise further expanding, for example inflating, the one or more first expandable bodies to thereby turn the person from a supine position to a lateral recumbent position. In this way, a person may simultaneously be supported on the bed and turned. The partially expanded bodies provide support preventing a person from falling out of bed. The support is provided in a safe and comfortable way.

The method may include controlling the feeding of top sheet material laterally across the mattress as the one or more first expandable bodies is expanding to keep the person in a controlled location on the mattress.

The controller may control displacement of the top sheet material. For example, top sheet material at one side of the bed may be unwound from a roller at that side so that it may displace across the mattress, whereas top sheet material may be held at the other side of the bed. A motor, for example a stepper motor, may drive the roller. The motor may be controlled by a processor in the control box. By controlling the displacement of the top sheet material in this way, the person may be kept in a controlled location on the mattress during and after turning.

The force to drive a roller to unwind or unwind top sheet material may be provided by a motor. The top sheet material may provide a force to drive a roller. A spring force may drive a roller.

In the method of the fourth aspect, when further expanding (inflating) the one or more first expandable bodies, the further expansion (inflation) may proceed initially in a region of the one or more first expandable bodies underneath the shoulders of the person.

By initially proceeding the step of the further expanding (inflating) in a region of the one or more first expandable bodies which is underneath the shoulders of the person, the person may be turned more efficiently and more comfortably.

The present specification discloses steps for carrying out the method of operating a bed according to the third aspect, the steps being: utilising one or more pressure sensors located in the top sheet to sense the presence of a person lying on the mattress; expanding partially each of the one or more first expandable bodies and the one or more second expandable bodies, for example by inflating partially each of the one or more first expandable bodies and the one or more second expandable bodies, thereby supporting the person on the bed; causing the top sheet feed system to hold the top sheet material at a first side of the mattress and to allow the top sheet material at an opposite second side of the mattress to run freely; expanding the one or more first expandable bodies, for example by inflating the one or more first expandable bodies, thereby turning the person on the bed. It may be that while expanding the one or more first expandable bodies, the one or more second expandable bodies may be contracted. Expanding the one or more first expandable bodies and contracting the one or more second expandable bodies, typically contemporaneously, further facilitates turning the person on the bed.

In a fifth aspect of the present invention, the present specification discloses a method of operating a bed according to the third aspect, said method comprising partially expanding, for example inflating, the one or more first expandable bodies and partially expanding, for example inflating, the one or more second expandable bodies to thereby support the person. A person lying on the bed is prevented from falling out of bed by the first and second one or more partially expanded bodies.

The steps may be carried out by a processor, such as a microprocessor. The method may be performed by a controller instructed by a processor, such as a microprocessor or computer. The controller may be housed in the control box. The controller may be configured to transmit data remotely for display and/or recording. The controller is typically in electronic communication with a user interface, for example via a wired or a wireless interface.

In a sixth aspect, the present specification discloses a kit of parts for providing an apparatus for turning a person on a mattress of a bed, the kit comprising: a top sheet which, when the apparatus is fixed to the bed, extends across the mattress of the bed; one or more first expandable bodies capable of providing cushioning between the top sheet and the mattress in a first portion (e.g. half) of the mattress; and one or more second expandable bodies capable of providing cushioning between the top sheet and the mattress in a second portion (e.g. half) of the mattress; whereby the top sheet is displaceable across the one or more first expandable bodies and the one or more second expandable bodies.

The invention extends in a seventh aspect to a sheet adapted for use with the invention of any of the other aspects.

Optional features of any aspect of the invention are optional features of every aspect of the invention.

### DESCRIPTION OF THE DRAWINGS

An example embodiment of the present invention will now be illustrated with reference to the following Figures in which:

FIG. 1 is a diagram of a profiling bed with an embodiment mounted.

FIG. 2 is a cross-sectional view through a first expandable body and a second expandable body.

FIG. 3 is an exploded view of a profiling bed with an embodiment of the present apparatus mounted.

FIG. 4(a) shows a detail of the side of the bed with an embodiment mounted; FIG. 4(b) shows a cross-sectional view of the top sheet wound onto a roller.

FIG. 5 illustrates a sensor sheet with an array of sensors.

FIG. 6 is a schematic illustration of the sensor sheet and an array of sensors.

FIG. 7 illustrates air bags on a base layer.

FIG. 8(a) a profiling bed with an embodiment of the present apparatus mounted; FIG. 8(b) an end-on cross-sectional view of the profiling bed, apparatus for turning a person, and a person lying supine on the apparatus; FIG. 8(c) an end-on cross-sectional view of the profiling bed, apparatus for turning a person, and a person lying supine on the apparatus, with the one or more first and the one or more second expandable bodies partially inflated in preparation for turning; FIG. 8(d) an end-on cross-sectional view of the profiling bed, apparatus for turning a person, and a person turned in a lateral recumbent position, with the one or more first expandable bodies fully inflated and the one or more second expandable bodies partially inflated. FIG. 9 illustrates an expandable body comprising a plurality of air bags.

### DETAILED DESCRIPTION OF AN EXAMPLE EMBODIMENT

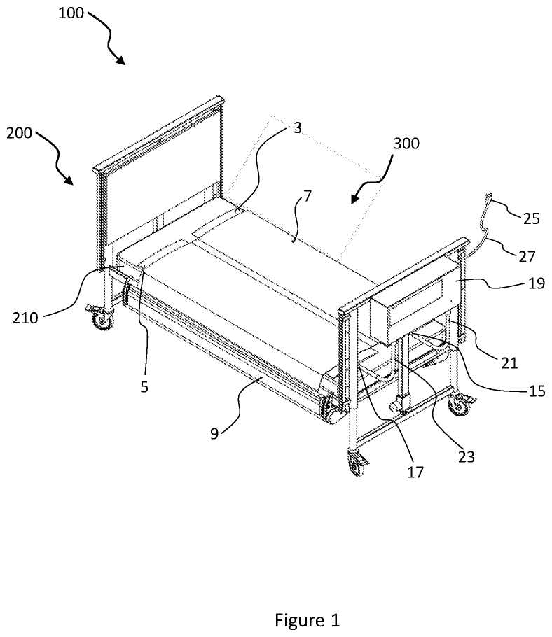

FIG. 1 illustrates a system 100 comprising a profiling bed 200 and an apparatus 300 for turning a person on the bed. A first inflatable chamber 3 is positioned on a first portion 212 of the mattress 210, and a second inflatable chamber 5 is positioned on a second portion 214 of the mattress 210. Each of the first inflatable chamber 3 and the second inflatable chamber 5 extends in length along a side of the mattress 210, from the end of the mattress 210 where a person lying on the mattress would put their head, to the end of the mattress where the person's feet would be located. The first inflatable chamber 3 extends in width from a first side of the top surface of the mattress 210 into the middle region of the top surface of the mattress. The second inflatable chamber 5 extends similarly in width from the second side of the top surface of the mattress 210 into the middle region of the top surface of the mattress. A gap between the first inflatable chamber 3 and the second inflatable chamber 5 runs down the centre of the top surface of the mattress.

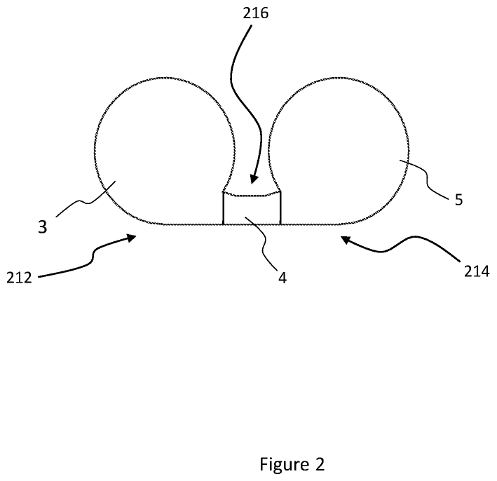

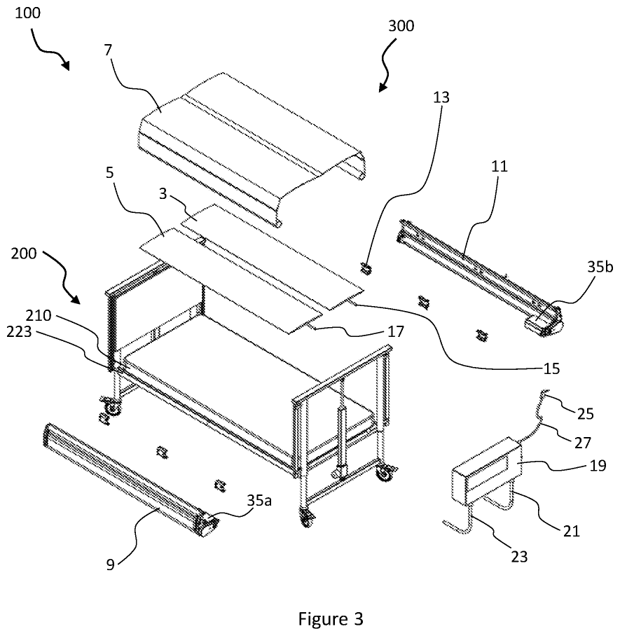

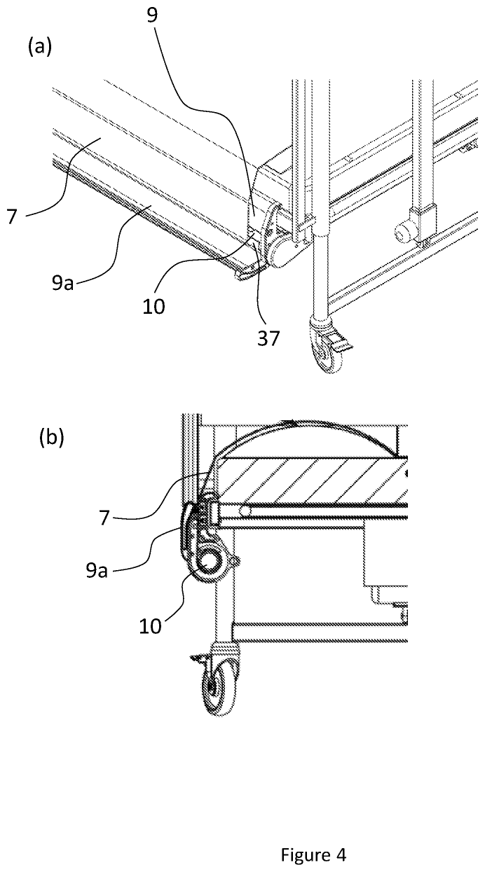

FIG. 2 illustrates a cross-sectional view through a first inflatable chamber 3 and a second inflatable chamber 5, separated by a gap 216, upon which the person lies. A connecting body 4 is provided in the region of the gap, which connecting body 4 is inflatable independently of first inflatable chamber 3 and second inflatable chamber 5. Top sheet 7 stretches over the first and second inflatable chambers 3, 5. An elongated retainer 9, 11 at each side of the bed retains the top sheet 7 at the sides of the bed. One of these retainers 9 can be seen in the view of FIG. 1. The second retainer 11 can be seen in the exploded view of FIG. 3. Interface brackets 13 are used to connect the elongated retainers 9, 11 to the bed. The interface brackets 13 are affixed to the bed frame 223, by screws in this embodiment. An elongated retainer fits into a universal docking system of the interface bracket. Each elongated retainer 9, 11 comprises a roller 10, onto which the top sheet 7 is rolled. Each elongated retainer 9, 11 comprises a hinged cover 9a, 11a. The hinged cover 9a is opened to give access to the roller 10. FIG. 4(a) shows a detail of an open hinged cover 9a on one side of a bed. By opening the hinged cover, the top sheet may be attached to the roller. In this embodiment the top sheet 7 is attached to roller 10 via a hook and loop Velcro connection 37. A Velcro hook strip is attached to the underside of top sheet 7 and attaches to a corresponding Velcro loop strip on roller 10. When mounting the top sheet on the bed, an operator typically attaches top sheet 7 to the roller by first opening the hinged cover 9a, before connecting the cooperative strips on the top sheet and the roller 37. The roller 10 is then rotated to wind the top sheet onto the roller 37 whereby through a combination of the hook and loop connection and the section of top sheet which is wound on the roller, the top sheet 7 is securely held on the roller. Once the top sheet is mounted on a roller, the hinged cover is closed again. A cross sectional view of a roller 10 with top sheet 9 wound on it is shown in FIG. 4(b).

A motor 35a, 35b is provided on each elongated retainer 9, 11 to drive the roller. The roller can be locked in position. The motor may lock the roller. A brake may lock the roller. The roller can be driven to unwind top sheet from the roller (typically to feed it laterally across the mattress). The roller can be driven to wind top sheet onto the roller (typically to take up slack top sheet on the mattress).

When the top sheet 7 extends across the width of the mattress and is attached to a roller at each side of the bed, the rollers may wind the top sheet so as to draw it taught.

The roller 10 at each side of the bed can be locked, thereby holding the top sheet 7 in position. Equally, a roller at one side of the bed can be unlocked, thereby allowing top sheet 7 which is wound on the roller to be unwound, enabling top sheet 7 to be displaced laterally across the top of the inflatable chambers 3, 5. Excess top sheet 7 can also be taken up by a roller by winding the top sheet onto the roller.

The main structural element of each elongated retainer is formed from extruded aluminium. The end plates of an elongated retainer are made from cast aluminium. The roller and the hinged cover are also made from aluminium. Covers which provide safety protection against metal edges are made from injection moulded plastic.

Each of first and second inflatable chambers 3, 5 is a single generally tubular chamber and is made from polyurethane. An air entry line 15, 17 is located at the end of each chamber 3, 5. Each inflatable chamber 3, 5 may be inflated by passing air into the bag through the appropriate entry line 15, 17.

Air for inflating the inflatable chambers 3, 5 is produced by a diaphragm pump 39 located in control box 19. Air is controllably supplied from the control box 19 via control supply lines 21, 23 to each of first expandable chamber 3 and second expandable chamber 5. Operation of the apparatus 300 for turning a person on the bed, including control of the air supplied into the inflatable chambers can be controlled via a handset 25 attached to the control box. The control box 19 contains a processor 33 which performs routines for operating the apparatus 300.

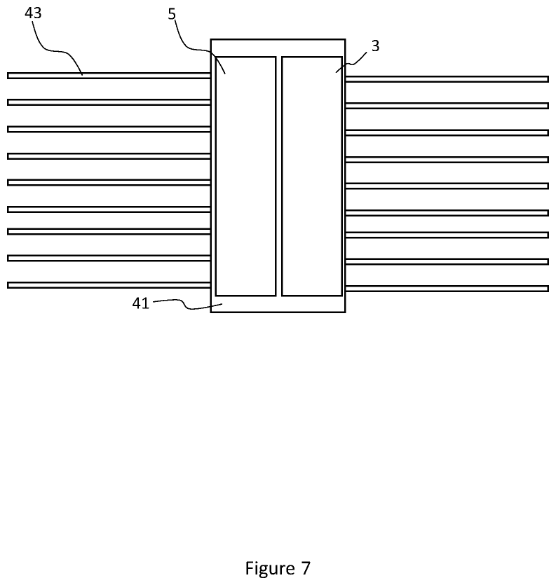

The apparatus for turning a person on the bed may further comprise a base sheet 41, between the mattress 210 and the first and second expandable bodies 3, 5. The first and second expandable bodies 3, 5 may be attached to the base sheet 41. For example, the first and second expandable bodies 3, 5 may be attached to the base sheet 41 by hook and loop (Velcro) connections. Alternatively, the first and second expandable bodies 3, 5 may be plastic welded to the base sheet 41. A base sheet 41 with first and second expandable bodies 3, 5 is illustrated in FIG. 7. FIG. 7 also shows nine pairs of straps 43 for attaching the apparatus to the mattress 210 of a bed. Each of the pairs straps are fastened together using Velcro, a buckle, or another mechanism known to the person skilled in the art.

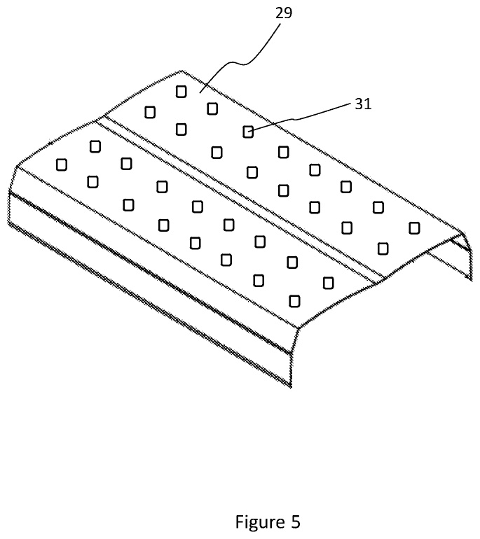

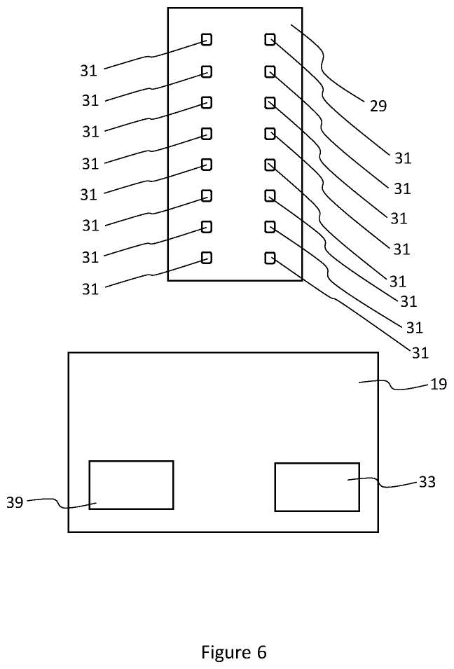

FIG. 5 shows a sensor sheet 29 which may form part of the apparatus 300 for turning a person on the bed. The sensor sheet has an array of pressure sensors 31 incorporated in it. When incorporated into the apparatus 300, the sensor sheet is sandwiched between the top sheet 7 and the inflatable chambers 3, 5. The pressure sensors 31 enable pressure points where the weight of a person lying on the bed is concentrated. The pressure point data is communicated to the processor 33 in the control box 19, and the processor 33 decides to operate the apparatus dependent on the pressure point data. For example, a person lying on the bed applies pressure at various contact points with the bed. If enhanced pressure is sensed at a particular location on the top surface of the bed for a period of time extending beyond a set limit, the processor 33 will operate the apparatus 300 to turn the person, thereby alleviating the pressure.

The sensor sheet 29 moves with the top sheet 9. When top sheet 9 displaces laterally across the bed, sensor sheet 29 matches the displacement.

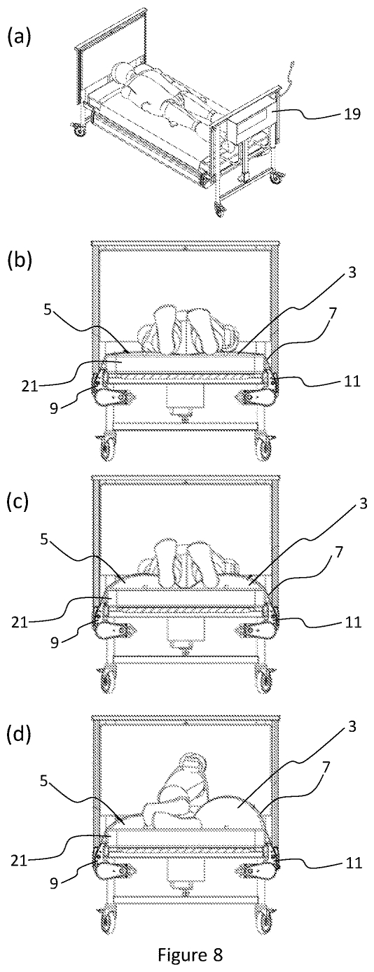

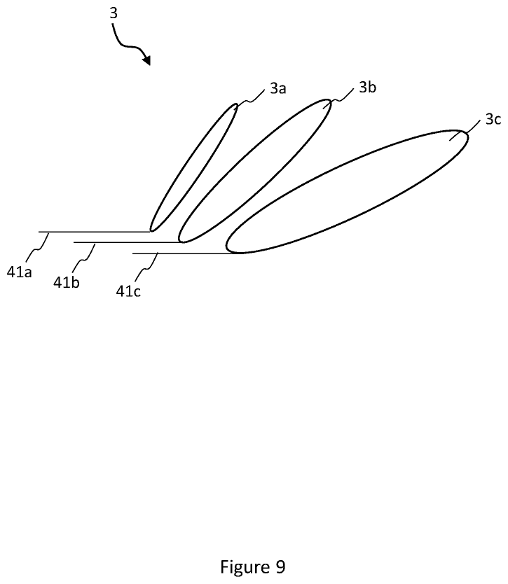

Operation of the apparatus to turn a person lying on the bed from a supine position to a lateral recumbent position, in which the person lies on their side, is illustrated in FIG. 8. FIG. 8(a) shows a diagram of a person lying supine on a profiling bed incorporating an embodiment of the present invention. FIG. 8(b) is a cross-sectional view of a person lying supine on the profiling bed taken at a cross-section just beyond the person's feet. The person lies approximately centrally on the bed. The left portion of their body is over first expandable chamber 3 and the right portion of their body is over second expandable chamber 5. In a first step, air is blown into each of the first expandable chamber 3 and the second expandable chamber 5 causing each chamber to partially expand. The person is thereby supported on both sides by the inflatable chambers. In a further step the expandable bag on the left side of the person is further inflated by pumping air into it. At the same time, the roller on the left side of the person is blocked so that it holds the top sheet material 7 on this side of the bed. The roller on the right side of the person is driven by its associated stepper motor 35a to feed top sheet material. The speed at which top sheet material is fed from the roller is coordinated with the rate at which the air bag 3 is inflated. The coordination is such that the person lying on the bed and turning from a supine position by the inflation of air bag 3 is maintained in an approximately central position on the mattress 21. In this way, the person is prevented from rolling towards the edge of the bed during the process of turning.

In some embodiments it is not necessary to actively feed the top sheet material, simply to clamp it on one side of the bed and allow material on the other side to be pulled through the roller.

FIG. 9 shows a schematic cross-sectional view of an expandable body with a layered structure. Expandable body bag 3 is made up of three inflatable chambers 3a, 3b, 3c. Each inflatable chamber is attached to a flap. Each of the flaps is attached to the mattress 21, or to the base sheet 41. Three flaps are illustrated, but alternatively, a single flap may be used for all the inflatable chambers.

In some embodiments the apparatus includes the mattress. In some embodiments, the apparatus is demountably attached to a profiling bed. In some embodiments, the apparatus is part of a profiling bed. In some embodiments, the rollers may be attached to channels, or in further embodiments to the side or sides of the bed. In some embodiments, an inflatable layer for the comfort of the person on the bed is present. In some embodiments, the top sheet may be in the form of a loop. In some embodiments, the inflatable chamber may be configured so that, during inflation, it curls around itself, and/or rotates around an axis. In some embodiments, the apparatus may comprise an additional expandable body or bodies, for example, an inflatable chamber, positioned, when expanded or inflated, to stop the knees of a person lying on the bed from knocking together. In some embodiments, the apparatus may comprise an inflatable chamber, positioned to act as a support for the head of a person lying on the bed. In some embodiments there is more than one first expandable body, which may be controlled, e.g. inflated or deflated, independently or together. In some embodiments there is more than one second expandable body, which may be controlled, e.g. inflated or deflated, independently or together.

1. An apparatus for turning a person on a mattress of a bed, the apparatus comprising:
one or more first expandable bodies capable of providing cushioning between the top sheet and the mattress in a first portion of the mattress; and
one or more second expandable bodies capable of providing cushioning between the top sheet and the mattress in a second portion of the mattress.

2. The apparatus according to claim 1, wherein the apparatus is configured to turn the person at a controlled location on the mattress.

3. The apparatus according to claim 1 whereby the apparatus comprises the mattress.

4. The apparatus according to claim 1, further comprising a top sheet which, when the apparatus is fixed to the bed, extends across the mattress;
whereby the top sheet is displaceable across the one or more first expandable bodies and the one or more second expandable bodies; and optionally, further comprising a first elongated retainer for retaining the top sheet along said first side of the bed

5. (canceled)

6. The apparatus according to claim 1, further comprising a top sheet feed system configurable to hold top sheet material at a first side of the bed and contemporaneously to wind or unwind top sheet at a second side of the bed.

7. The apparatus according to claim 1, further comprising fixing means for fixing said apparatus to the bed.

8. The apparatus according to claim 1, whereby the one or more first expandable bodies comprises an inflatable chamber.

9. The apparatus according to claim 1, whereby the one or more first expandable bodies comprises a plurality of inflatable chambers arranged in a layered structure.

10. The apparatus according to claim 1 further comprising an air supplier for supplying air to each of the one or more first expandable bodies and the one or more second expandable bodies, further comprising a vent for controllably releasing air from an expandable body.

11. (canceled)

12. The apparatus according to claim 6, configured such that the top sheet feed system operates in cooperation with the air supplier and/or the vent of an expandable body.

13. The apparatus according to claim 1, further comprising a base sheet, whereby the one or more first and the one or more second expandable bodies are positioned in a layer between the base sheet and said top sheet.

14. The apparatus according to claim 1, further comprising one or more sensors.

15. (canceled)

16. (canceled)

17. A bed comprising an apparatus according to claim 1.

18. A method of operating a bed according to claim 17, said method comprising expanding the one or more first expandable bodies to thereby turn the person in a controlled position on the bed.

19. (canceled)

20. (canceled)

21. The method according to claim 18, whereby in a first step partially expanding each of the one or more first expandable bodies and the one or more second expandable bodies, thereby supporting the person on two sides, and in a second step further expanding only the one or more first expandable bodies to thereby turn the person.

22. The method according to claim 18, including controlling the feeding of top sheet material laterally across the mattress as the one or more first expandable bodies is expanding to keep the person in a controlled location on the mattress.

23. The method according to claim 18, whereby when further expanding the one or more first expandable bodies, the further expansion proceeds initially in a region of the one or more first expandable bodies underneath the shoulders of the person.

24. The method of operating a bed according to claim 18, said method comprising partially expanding the one or more first expandable bodies and partially expanding the one or more second expandable bodies to thereby support the person.

25. A kit of parts for providing an apparatus for turning a person on a mattress of a bed, the kit comprising:
one or more first expandable bodies capable of providing cushioning between the top sheet and the mattress in a first portion of the mattress; and
one or more second expandable bodies capable of providing cushioning between the top sheet and the mattress in a second portion of the mattress.

26. An apparatus for turning a person on a mattress of a bed, the apparatus configured to maintain the person at a controlled location on the mattress, wherein the apparatus comprises one or more expandable bodies capable of overcoming the inertia of a person in a generally horizontal position.
